(19) United States
(12) Patent Application Publication
(10) Pub. No.: US 2009/0154551 A1
(43) Pub. Date: Jun. 18, 2009

(54) APPARATUS FOR RECORDING/REPRODUCING MOVING PICTURE, AND RECORDING MEDIUM THEREOF

(75) Inventors: Yoichiro Tauchi, Yokohama (JP); Mineki Taoka, Yokohama (JP)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/328,918

(22) Filed: Dec. 5, 2008

(30) Foreign Application Priority Data
Dec. 12, 2007 (JP) 2007-321129

(51) Int. Cl. H04N 11/04; H04N 5/91

(52) U.S. Cl. 375/240.01; 386/83; 375/E07.001

(57) ABSTRACT

An apparatus for recording/reproducing a moving picture, and a recording medium thereof, are provided. The apparatus for recording a moving picture includes a recorder which records moving picture data sequentially outputted from an image pickup device in a frame unit as raw image data to a recording medium, and a compression processor, which generates compressed image data by compressing the moving picture data, wherein the recorder records the moving picture data by corresponding the raw image data to the compressed image data in the frame unit. Accordingly, the raw image data outputted from the image pickup device is recorded while the raw image data is easily handled.

### CROSS-REFERENCE TO RELATED PATENT APPLICATION

This application claims the benefit of Japanese Patent Application No. 2007-321129, filed on Dec. 12, 2007 in the Japanese Intellectual Property Office, the entire contents of which is incorporated herein by reference.

### BACKGROUND OF THE INVENTION

1. Field of the Invention

The present invention relates to an apparatus for recording/reproducing a moving picture, and a recording medium thereof. More particularly, the present invention relates to an apparatus for recording/reproducing a moving picture, and a recording medium thereof, which can simultaneously record raw image data outputted from an image pickup device, and easily perform a method of handling the raw image data.

2. Description of the Related Art

A photographing apparatus, such as a video camera, and/or a camcorder, and the like, that can record a moving picture generally performs a predetermined image processing operation on a signal outputted from an image pickup device, such as a charge coupled device (CCD), performs a compressing operation according to MPEG-2, and then records the moving picture on a recording medium, such as a flash memory, a hard disk drive (HDD), or a digital versatile disk (DVD). As disclosed in JP 2006-229474, a still image camera records an output of an image pickup device in raw image data. Generally, when a compressing operation is performed on an image, the quality of the image after the compression deteriorates as compared to the quality of the image before the compression. Accordingly, a photographing apparatus, such as a digital camera for recording a still image, sometimes directly records a signal outputted from an image pickup device as raw data without performing a compressing operation on the image.

Also, JP 2003-348542 discloses a camcorder that simultaneously records a high-quality moving picture and a low bit rate moving picture.

However, conventional technologies do not disclose a technique of recording a moving picture in raw image data without compression. When a moving picture is recorded in raw image data, it is possible to reproduce a high-quality image. However, the size of the raw image data becomes very large. As a result, real-time recording during photographing is difficult. Also, when a thumbnail is indicated or searched for by using the raw image data after such photographing, the associated throughput increases, and complex processes are required as a result.

### SUMMARY OF THE INVENTION

The present invention provides an apparatus for recording/reproducing a moving picture, and a medium thereof, which can simultaneously record raw image data outputted from an image pickup device, and easily perform a method of handling the raw image data.

According to an embodiment of the present invention, an apparatus for recording a moving picture is provided. The apparatus includes: a recorder which records moving picture data sequentially outputted from an image pickup device in a frame unit as raw image data to a recording medium; and a compression processor which generates compressed image data by compressing the moving picture data, wherein the recorder records the moving picture data by corresponding the raw image data to the compressed image data in the frame unit.

According to the apparatus, the moving picture data sequentially outputted from the image pickup device in the frame unit is recorded to the recording medium as the raw image data. Also, the compressed image data is generated by compressing the moving picture data, and the raw image data is recorded to the recording medium by corresponding the raw image data to the compressed image data in the frame unit. Accordingly, both the raw image data and the compressed image data are recorded in relation to each other, and thus the raw image data is used for high-quality reproduction, and the compressed image data having low data amount is used for real-time display and image searching. Consequently, the apparatus can provide high-quality images, and be easily manipulated.

The recorder sequentially may record the compressed image data and the raw image data in a recording format of the recording medium by corresponding the raw image data to the compressed image data in the frame unit. Because the compressed image data and the raw image data are sequentially recorded in the recording format of the recording medium, the compressed image data that is recorded before the raw image data is reproduced without processing the raw image data, when the raw image data is not required to be reproduced.

The apparatus may further include an audio encoder which generates audio data by encoding audio, wherein the recorder corresponds the audio data, the compressed image data, and the raw image data in the frame unit with each other, and sequentially records the audio data, the compressed image data, and the raw image data in the recording format of the recording medium. Since the audio data, the compressed image data, and the raw image data are sequentially recorded in the recording format of the recording medium, the audio data and the compressed image data that are recorded before the raw image data can be reproduced without processing the raw image data, when the raw image data is not required to be reproduced.

The apparatus may further include a data size determiner which determines data sizes of the audio data, the compressed image data, and the raw image data in the frame unit, wherein the recorder records the data sizes of the audio data, the compressed image data, and the raw image data in the recording medium according to each frame. Since the data sizes of the audio data, the compressed image data, and the raw image data are recorded according to each frame, any one of the audio data, the compressed image data, and the raw image data can be skipped according to the data sizes.

According to another embodiment of the present invention, an apparatus for reproducing a moving picture is provided. The apparatus includes: an operation mode input unit which receives an operation mode; a data reader which records moving picture data sequentially outputted from an image pickup device in a frame unit as raw image data, and simultaneously reads at least one of the raw image data, compressed image data that is generated by compressing the moving picture data, and audio data according to the operation mode from a recording medium having recorded thereon the compressed image data and the audio data corresponding to the raw image data in the frame unit; a developing processor which develops the raw image data read by the data reader; a decoder which decodes the compressed image data read by the data reader; an image output unit which outputs a signal from the developing processor or the decoder; and an audio output unit which outputs the audio data.

According to the apparatus, the moving picture data sequentially outputted from the image pickup device in a frame unit is recorded as the raw image data, and simultaneously, at least one of the raw image data, the compressed image data that is generated by compressing the moving picture data, and the audio data are read according to the operation mode inputted to the operation mode input unit, from the recording medium having recorded thereon the compressed image data and the audio data correspondingly to the raw image data in the frame unit. The raw image data read by the data reader is developed and then outputted, the compressed image data read by the data reader is decoded and then outputted, and the audio data is outputted. Accordingly, by reading and reproducing at least one of the raw image data, the compressed image data, and the audio data from the recording medium, reproduction can be efficiently performed according to the operation mode inputted to the operation mode input unit.

According to another embodiment of the present invention a computer readable recording medium having recorded thereon a program for executing a method of recording a moving picture is provided. The method includes: recording moving picture data sequentially outputted from an image pickup device in a frame unit as raw image data to a recording medium; generating compressed image data by compressing the moving picture data; and recording the moving picture data by corresponding the raw image data to the compressed image data in the frame unit.

According to the computer readable recording medium, the moving picture data sequentially outputted from the image pickup device in the frame unit is recorded to the recording medium as the raw image data. Also, the compressed image data is generated by compressing the moving picture data. Also, the raw image data is recorded in the recording medium by corresponding the raw image data to the compressed image data in the frame unit. Accordingly, the raw image data and the compressed image data are recorded in relation to each other, and thus the raw image data is used for high-quality reproduction and the compressed image data having low data amount is used for real-time display and image search. Consequently, the moving picture data having high-quality and excellent manipulation is recorded.

According to another embodiment of the present invention, a computer readable recording medium having recorded thereon a program for executing a method of reproducing a moving picture is provided. The method includes: recording moving picture data sequentially outputted from an image pickup device in a frame unit as raw image data, and simultaneously reading at least one of the raw image data, compressed image data that is generated by compressing the moving picture data, and audio data according to an operation mode from a recording medium having recorded thereon the compressed image data and the audio data correspondingly to the raw image data in the frame unit; developing the read raw image data; decoding the read compressed image data; outputting a signal from the developing of the read raw image data or the decoding of the read compressed image data; and outputting the audio data.

According to the computer readable recording medium, the moving picture data sequentially outputted from the image pickup unit in the frame unit is recorded as the raw image data, and simultaneously, at least one of the raw image data, the compressed image data that is generated by compressing the moving picture data, and the audio data is read according to the operation mode inputted to the operation mode input unit, from the recording medium having recorded thereon the compressed image data and the audio data correspondingly to the raw image data in the frame unit. Also, the raw image data read by the data reader is developed and the outputted, the compressed image data read by the data reader is decoded and then outputted, and the audio data is outputted. Accordingly, by reading and reproducing at least one of the raw image data, the compressed image data, and the audio data from the recording medium, reproduction can be efficiently performed according to the operation mode inputted to the operation mode input unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating an example of an apparatus for recording a moving picture according to an embodiment of the present invention.

FIGS. 2(A), (B), and (C) are diagrams illustrating an example of a recording format of a recording medium according to the apparatus for recording a moving picture;

FIG. 3 is a diagram for describing an example of a method of reading and reproducing only audio data and compressed image data while reproducing developing process image data.

FIG. 4 is a block diagram illustrating an example of an apparatus for reproducing a moving picture according to an embodiment of the present invention.

### DETAILED DESCRIPTION OF THE INVENTION

Hereinafter, the present invention will be described in detail with reference to the accompanying drawings in which exemplary embodiments of the invention are shown. In the drawings, like reference numerals denote like elements.

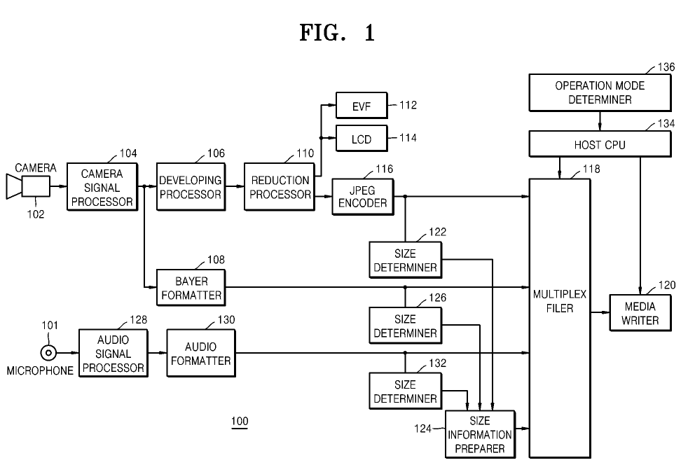

FIG. 1 is a block diagram illustrating an example of an apparatus 100 for recording a moving picture according to an embodiment of the present invention. As illustrated in FIG. 1, the apparatus 100 includes a camera signal processor 104, which receives moving picture data outputted from an image pickup device (a sensor such as a charge coupled device (CCD) or a complementary metal oxide semiconductor (IOS)) of a camera 102, according to each frame. The camera signal processor 104 includes an analog-to-digital (A/D) converter (not shown), which converts a received signal from analog to digital.

A digital image signal outputted from the camera signal processor 104 is transmitted to both a developing processor 106 and a Bayer formatter 108. The developing processor 106 performs a series of developing processes on the received digital image signal, such as a white balance process, an interpolation process from a Bayer arrangement, a noise removing process, and luminescence and color compensating processes.

Data that is developed in the developing processor 106 is transmitted to a reduction processor 110. When required, the reduction processor 110 reduces the size of the moving picture data according to a screen size of a display device, such as an electronic viewfinder (EVF) 112 or a liquid crystal display (LCD) 114. Data outputted from the reduction processor 110 is transmitted to the EVF 112 or the LCD 114 to be displayed on a screen thereof. Accordingly, a user can recognize an image captured by the camera 102 in real-time.

Also, data outputted from the reduction processor 110 is transmitted to a JPEG encoder 116 that performs JPEG compression encoding on the received data, and transmits the data to a multiplex filer 118. The multiplex filer 118 temporarily gathers compressed image data, i.e., the image data compressed in the JPEG encoder 116. A size determiner 122 determines the data size of the compressed image data input to the multiplex filer 118, and transmits the data size to a size information preparer 124.

The Bayer formatter 108 re-arranges each signal of R, G, and B of the digital converted image data to a Bayer format. Also, the Bayer formatter 108 performs a reversible compression process on the image data. Through the reversible compression process, the image data can be recorded and reproduced without deteriorating the quality of an image. A reversible compressing method includes, for example, entropy encoding according to a Huffman encoding of data differential in a frame. The reversible compressing method is not limited to strict reversibility. As such, the Bayer format process performed in the Bayer formatter 108 does not perform a compression process that deteriorates the quality of an image, in order to maintain the quality of the raw image data. Meanwhile, the size of the raw image data is very big, and thus data having a small redundancy is processed.

The moving picture data that is Bayer formatted by the Bayer formatter 108 is transmitted to the multiplex filer 118 as raw image data. The multiplex filer 118 accumulates the raw image data from the Bayer formatter 108. A size determiner 126 determines the size of the raw image data input to the multiplex filer 118, and transmits the size to the size information preparer 124.

Also, a microphone 101 captures audio of a subject while the camera 102 takes a moving picture, and transmits an audio signal to an audio signal processor 128. The audio signal processor 128 includes an A/D converter (not shown), which converts an analog audio signal to a digital audio signal. The digital audio signal output from the audio signal processor 128 is transmitted to an audio formatter 130 that formats audio data by using a non-compression PCM method or a compression method, such as an ADPCM method, an ACC method, an AC3 method, or an MP3 method, for example. The audio data formatted by the audio formatter 130 is transmitted to the multiplex filer 118. The multiplex filer 118 temporarily accumulates the audio data. A size determiner 132 determines the size of the audio data input to the multiplex filer 118, and transmits the size to the size information preparer 124.

The compressed image data, the raw image data, and the audio data accumulated in the multiplex filer 118 are transmitted to a media writer 120, and are recorded to a recording medium (not shown) according to a recording format of the recording medium. Examples of the recording medium include an optical recording medium, such as a CD or a DVD, a magneto-optical disk, a magnetic disk, and a semiconductor memory medium, and the like.

A host CPU 134 controls data transmission from the multiplex filer 118 to the media writer 120, and the recording of data on the recording medium by the media writer 120. The host CPU 134 transmits a predetermined amount, for example, a data amount per frame, of the compressed image data, the raw image data, and the audio data accumulated in the multiplex filer 118 to the media writer 120, and controls the multiplex filer 118 and the media writer 120 so that the compressed image data, the raw image data, and the audio data are sequentially recorded in the recording medium. The host CPU 134 records the compressed image data, the raw image data, and the audio data in a predetermined order in the recording medium, and simultaneously records their data sizes received from the size information preparer 124 in a predetermined area of the recording medium.

An operation mode determiner 136 determines an operation mode according to an input of the user, and transmits the determined operation mode to the host CPU 134. The host CPU 134 controls the recording of data in the recording medium by the multiplex filer 118 and the media writer 120, according to the operation mode determined by the operation mode determiner 136.

The series of operations performed in the apparatus 100 may be processed with hardware or a software program in a computer.

In the apparatus 100 according to the current embodiment of the present invention, the digital image data that is outputted from the image pickup device of the camera 102 and then A/D converted is transmitted to the Bayer formatter 108, and then recorded in the recording medium as the raw image data. Accordingly high-quality raw image data is recorded in the recording medium, and a high-quality image can be reproduced as compared to the compressed image data obtained by reading and displaying the raw image data.

Also, since the amount of the raw image data is large, an image cannot be displayed in real-time on the EVF 112 or the LCD 114 by using the raw image data, and also a compressing process, such as JPEG, for example, cannot be directly performed on the raw image data. However in the apparatus 100 according to the current embodiment of the present invention, the raw image data is recorded while the moving picture data is developed, reduced, and compressed. Thus, the real-time display on the EVF 112 or the LCD 114 is possible during photographing, and an image can be photographed while monitoring a display screen included in the EVF 112 or the LCD 114, for example. Also the raw image data and the compressed image data are both recorded in the recording medium, and thus image search and thumbnail display are possible by using the compressed image data during reproduction. Accordingly, high-quality reproduction is possible by using the raw image data for an important part of an image. In addition, simple reproduction is possible by quickly reading the compressed image data for a part that is relatively not important in the image.

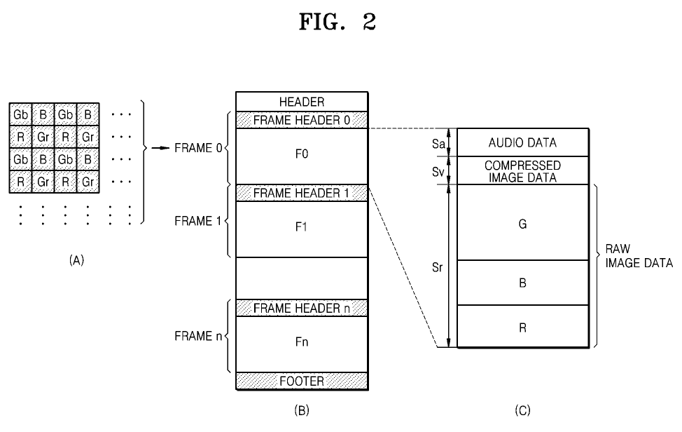

A recording format of a recording medium will now be described. FIGS. 2(A), (B), and (C) are diagrams illustrating an example of a recording format of a recording medium according to the apparatus 100 for recording a moving picture. Here, FIG. 2(A) illustrates an example of the raw image data before being re-arranged into RGB data by the Bayer formatter 108. As illustrated in FIG. 2(A), when the image pickup device is, for example, a single plate of a Bayer arrangement, data is outputted in an order of pixels having a Bayer arrangement of R:G:B=1:2:1. Since the apparatus 100 records such Bayer arranged data without damaging the quality of an image, the apparatus 100 records the data after re-arranging the data in an order of GBR by using the Bayer formatter 108, without performing a compressing process that may deteriorate the quality of the image.

FIG. 2(B) illustrates an example of one moving picture file from when recording of an image started to when recording of the image is stopped. FIG. 2(C) illustrates an example of data of one frame from among recorded data in FIG. 2(B).

The Bayer arranged data in FIG. 2(A) is re-arranged by the Bayer formatter 108, and is recorded in a data area of the recording medium. Also, the compressed image data encoded in the JPEG encoder 116 and the audio data formatted in the audio formatter 130 are recorded in the data area of the recording medium. As illustrated in FIG. 2(B), a header is recorded in front of the recording format. The header includes, for example, information about a setting, such as a language, a name of manufacturer, and a name of the setting, information about recording, such as a day and time of starting photographing and a day and time of finishing photographing, information about a camera, such as a number of pixels, a pixel pitch, a pixel arrangement, and a type of lens, information about a structure, such as a frame rate, a raw compression mode, a developing data compression mode, and an audio compression mode, and overall information, such as a number of channels of an audio, a number of bits, recording format information of a recording medium, and specification data of a lens of the camera. After the header, data is recorded according to a frame of the image.

The data according to each frame includes frame headers 0 through n, and data F0 through Fn according to each frame. A frame header includes information about a frame, such as, for example, an absolute frame number and a time code, and also information about a photographing condition, such as, for example, an iris value, a focus, ISO sensitivity, and an electronic shutter, and information about a flag for such, a title, and a data size (audio data, compressed image data, and raw image data). As illustrated in the example of FIG. 2(C), data according to each frame is recorded in an order of audio data, compressed image data, and raw image data (G, B, and R) in a frame unit. In this example, after the last data Fn, a footer is recorded. A footer includes information about a previous frame, such as, for example, the number of previous frames and a frame header address, and also information about photographing, such as importance and a type of scenes.

The data sizes of the audio data, the compressed image data, and the raw image data transmitted from the size information preparer 124 according to each frame are recorded in a frame header of each frame. Referring to the example of FIG. 2(C), a data size Sa of the audio data, a data size Sv of the compressed image data, and a data size Sr of the raw image data of a frame 0 is recorded in a frame header 0 of the frame 0. As such, by recording the data size of each data in a frame header of each frame, the data size can be obtained when the frame header is read during reproduction. Also, during the reproduction, each data is read by determining the number of the data, and thus the heads of the audio data, the compressed image data, and the raw image data can be quickly determined.

Accordingly, even when raw image data having a large data size is recorded, only audio data or compressed image data is reproduced according to information about data sizes recorded in a frame header, and then audio data or compressed image data of a next frame can be reproduced without reproducing raw image data of the next frame. As a result, image search or quick reproduction is possible by reproducing only the audio data or the compressed image data without reproducing the raw image data, regarding a moving picture having relatively low importance from among moving pictures. Also, high-quality reproduction is possible by reproducing the raw image data, regarding a moving picture having relatively high importance from among the moving pictures. Moreover, the audio data can be quickly read by recording the audio data in front of the data of each frame.

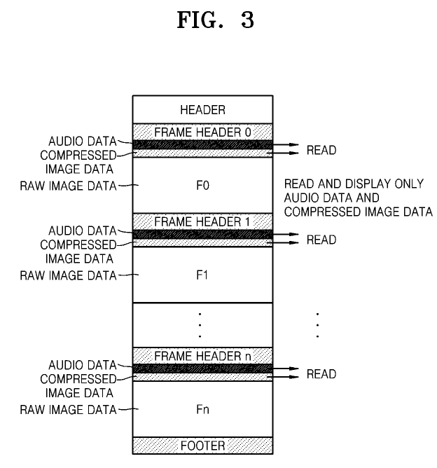

FIG. 3 is a diagram for describing an example of a method of reading and reproducing only audio data and compressed image data while reproducing developing process image data. Since the data sizes of audio data, compressed image data, and raw image data are recorded in each frame header, for example, it is possible to read only the audio data and the compressed image data and skip the raw image data, as illustrated in FIG. 3.

Accordingly, for example, an image is searched for by reproducing only the audio data and the compressed image data while skipping the raw image data, until a frame that requires the raw image data to be reproduced is reached, and when the frame that requires the raw image data to be reproduced is reached, the raw image data can be reproduced. According to such a format, the raw image data and the compressed image data are in a one-to-one correspondence, and thus it is possible to read the raw image data for a short time by relating a frame of the raw image data to the compressed image data.

A frame header may record three data sizes of audio data, compressed image data, and raw image data, but may record at least one or at least two of the three data sizes, for example. In such a format, unnecessary data can be skipped according to the recorded data sizes, and thus it is possible to read and reproduce only required data.

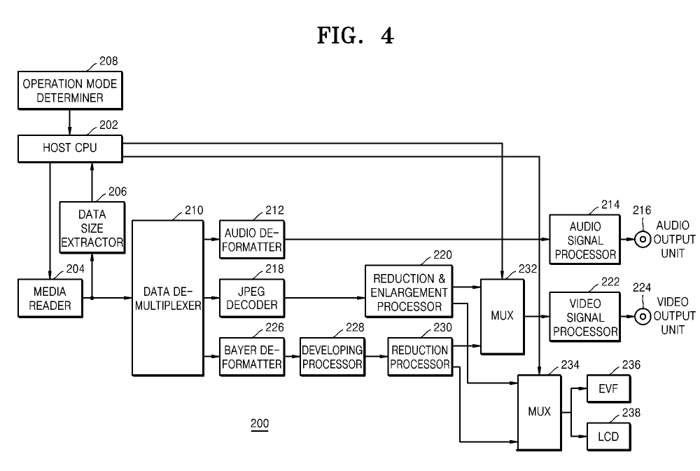

FIG. 4 is a block diagram illustrating an example of an apparatus 200 for reproducing a moving picture according to an embodiment of the present invention. The apparatus 200 of this example reproduces moving picture data recorded in the apparatus 100 of FIG. 1. As illustrated in the example of FIG. 4, the apparatus 200 includes a host CPU 202, a media reader 204, a data size extractor 206, an operation mode determiner 208, a data de-multiplexer 210, an audio de-formatter 212, an audio signal processor 214, an audio output unit 216, a JPEG decoder 218, a reduction & enlargement processor 220, a video signal processor 222, a video output unit 224, a Bayer de-formatter 226, a developing processor 228, a reduction processor 230, MUXes 232 and 234, an EVF 236, and an LCD 238.

The media reader 204 reads data from a recording medium (not shown) according to a command of the host CPU 202. The data size extractor 206 extracts data sizes of audio data, compressed image data, and raw image data recorded in a frame header, and transmits the extracted data sizes to the host CPU 202. The host CPU 202 controls reading of the data by the media reader 204 according to the received data sizes.

The operation mode determiner determines an operation mode during reproduction. Here, examples of the operation mode during reproduction include a raw image data producing mode, a compressed image data reproducing mode, and other specific reproducing modes, like a high-speed reproducing mode.

The data de-multiplexer 210 temporarily accumulates data read by the media reader 204, and transmits the accumulated data to the audio de-formatter 212, the JPEG decoder 218, and the Bayer de-formatter 226. Here, since the reading of data by the media reader 204 is performed according to the data sizes extracted by the data size extractor 206, the data de-multiplexer 210 can respectively transmit the audio data, the compressed image data, and the raw image data to the audio de-formatter 212, the JPEG decoder 218, and the Bayer de-formatter 226.

The audio de-formatter 212 de-formats the audio data and then transmits the audio data to the audio signal processor 214. The audio signal processor 214 D/A converts the de-formatted audio data and then transmits the audio signal to the audio output unit 216. The audio output unit 216 then outputs the analog audio signal.

Also, the JPEG decoder 218 decodes and transmits the compressed image data to the reduction & enlargement processor 220. The reduction & enlargement processor 220 reduces or enlarges the decoded compressed image data for the MUXes 232 and 234.

The Bayer de-formatter 226 Bayer de-formats the raw image data, re-arranges the raw image data in a Bayer-arrangement, and then transmits the raw image data to the developing processor 228. The developing processor 228 performs a series of developing processes on the de-formatted raw image data, such as a white balance process, an interpolation process from a Bayer arrangement, a noise removing process, and luminescence and color compensation processes. The reduction processor 230 reduces the size of the developed raw image data, and then transmits the raw image data to the MUXes 232 and 234.

According to a command of the host CPU 202, the MUX 232 transmits any one of the image data from the reduction & enlargement processor 220 and the image data from the reduction processor 230 to the video signal processor 222. The video signal processor 222 digital-to-analog (D/A) converts the received image data. The video output unit 224 outputs the image data received from the video signal processor 222.

According to a command of the host CPU 202, the MUX 234 transmits any one of the image data from the reduction & enlargement processor 220 and the image data from the reduction processor 230 to the EVF 236 and the LCD 238, which display the image data.

The series of processes performed in the apparatus 200 may be processed with hardware or software by a program in a computer.

As described above, in the apparatus 200 according to the current embodiment of the present invention, reproduction according to an operation mode is efficiently performed by extracting the data sizes of the audio data, the compressed image data, and the raw image data from the information in the header and each frame header from among the files read by the media reader 204, reading suitable data from the recording medium according to the operation mode determined by the operation mode determiner 208, and selecting the data output from the MUXes 232 and 234.

While reproducing the raw image data, the raw image data of G, B, and R is each read from the recording medium, and the raw image data is realized as an image by developing the raw image data. Such a signal is reduced to a predetermined image size so as to be output from the video output unit 224 or the EVF 236 and LCD 238. Accordingly, high-quality reproduction is possible in the apparatus 200.

When the compressed image data is reproduced, the compressed image data is reproduced by sequentially reading the compressed image data from the recording medium in a frame unit. In this case, the data size of the read compressed image data is much smaller than that of the raw image data. By reducing or enlarging the JPEG decoded image signal to a predetermined image size, the compressed image data is reproduced by using simpler processes than the raw image data. As such, by using a simple reproduction mode of the compressed image data, the structure of the hardware of the apparatus 200 can be remarkably reduced, and the power consumption of the apparatus 200 can be remarkably reduced.

Also in a high-speed reproduction mode, as a special reproduction mode, a process with a low load is possible by using the JPEG data. In this case, by searching only the frame header according to a speed rating rate of reproduction, the compressed image data is read by scanning the frame header after skipping over to a required frame based on information about the data sizes of the audio data, the compressed image data, and the raw image data, and then the compressed image data is JPEG-decoded in order to be read. Reproduction in a counter direction can be easily performed by using the same processes as described above.

An outline of a photographed image from among files can be indicated in a thumbnail by using the compressed image data. In this case, an image of one frame may be indicated in a thumbnail or each moving picture file may be indicated in a thumbnail as a moving picture regarding each of a plurality of moving picture files.

According to the current embodiment of the present invention, the raw image data and the compressed image data are recorded in relation to each other, and thus the raw image data is used for high-quality reproduction and the compressed image data having relatively low data amount is used for real-time display and image searching. Thus, the apparatuses 100 and 200 can provide high-quality images, and be easily manipulated.

According to the present invention, an apparatus for recording/reproducing a moving picture and a medium thereof can simultaneously record raw image data outputted from an image pickup device, and easily perform a method of handling the raw image data.

The invention can also be embodied as computer readable codes on a computer readable recording medium. The computer readable recording medium is any data storage device that can store data, which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet), and the like. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to preferred embodiments thereof, it will be understood by those of ordinary skill in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An apparatus for recording a moving picture, the apparatus comprising:
a recorder which records moving picture data sequentially outputted from an image pickup device in a frame unit as raw image data to a recording medium; and
a compression processor which generates compressed image data by compressing the moving picture data,
wherein the recorder records the moving picture data by corresponding the raw image data to the compressed image data in the frame unit.

2. The apparatus of claim 1, wherein the recorder sequentially records the compressed image data and the raw image data in a recording format of the recording medium by corresponding the raw image data to the compressed image data in the frame unit.

3. The apparatus of claim 1, further comprising an audio encoder which generates audio data by encoding audio,
wherein the recorder corresponds the audio data, the compressed image data, and the raw image data in the frame unit with each other, and sequentially records the audio data, the compressed image data, and the raw image data in the recording format of the recording medium.

4. The apparatus of claim 3, further comprising a data size determiner which determines data sizes of the audio data, the compressed image data, and the raw image data in the frame unit,
wherein the recorder records the data sizes of the audio data, the compressed image data, and the raw image data in the recording medium according to each frame.

5. An apparatus for reproducing a moving picture, the apparatus comprising:
an operation mode input unit which receives an operation mode;
a data reader which records moving picture data sequentially outputted from an image pickup device in a frame unit as raw image data, and simultaneously reads at least one of the raw image data, compressed image data that is generated by compressing the moving picture data, and audio data according to the operation mode from a recording medium having recorded thereon the compressed image data and the audio data corresponding to the raw image data in the frame unit;
a developing processor which develops the raw image data read by the data reader;
a decoder which decodes the compressed image data read by the data reader;
an image output unit which outputs a signal from the developing processor or the decoder; and
an audio output unit which outputs the audio data.

6. A computer readable recording medium having recorded thereon a program for executing a method of recording a moving picture, the method comprising:
recording moving picture data sequentially outputted from an image pickup device in a frame unit as raw image data to a recording medium;
generating compressed image data by compressing the moving picture data; and
recording the moving picture data by corresponding the raw image data to the compressed image data in the frame unit.

7. A computer readable recording medium having recorded thereon a program for executing a method of reproducing a moving picture, the method comprising:
recording moving picture data sequentially outputted from an image pickup device in a frame unit as raw image data, and simultaneously reading at least one of the raw image data, compressed image data that is generated by compressing the moving picture data, and audio data according to an operation mode from a recording medium having recorded thereon the compressed image data and the audio data correspondingly to the raw image data in the frame unit;
developing the read raw image data;
decoding the read compressed image data;
outputting a signal from the developing of the read raw image data or the decoding of the read compressed image data; and
outputting the audio data.
